(19) United States
(12) Patent Application Publication
(10) Pub. No.: US 2018/0173259 A1
(43) Pub. Date: Jun. 21, 2018

(54) Apparatus for Regulator with Improved Performance and Associated Methods

(71) Applicant: Silicon Laboratories Inc., Austin, TX (US)

(72) Inventors: Kenneth Mæland, OSLO (NO); Scott David Willingham, Austin, TX (US); Dag Mattis Pettersen, OSLO (NO)

(21) Appl. No.: 15/385,793

(22) Filed: Dec. 20, 2016

(51) Int. Cl. G05F 1/575

(52) U.S. Cl. CPC G05F 1/575

(57) ABSTRACT

An apparatus includes an integrated circuit (IC), which includes a voltage regulator. The voltage regulator includes a first transistor coupled to an input voltage of the voltage regulator and a first output of the voltage regulator. The first transistor includes a native device of the IC. The voltage regulator further includes at least one diode-connected transistor coupled to the first output of the voltage regulator.

### TECHNICAL FIELD

The disclosure relates generally to power conversion apparatus and, more particularly, to apparatus for voltage regulation with improved characteristics, and associated methods.

### BACKGROUND

Modern integrated circuits (ICs) have helped to integrate electronic circuitry to decrease size and cost. As a consequence, modern ICs can form complex circuitry and systems. For example, virtually all of the functionality of a system may be realized using one or a handful of ICs. Such circuitry and systems may receive and operate on both analog and digital signals, and may provide analog and digital signals.

The result has been a growing trend to produce circuitry and systems with increased numbers of transistors and similar devices. The circuitry and systems typically operate from supply voltages that might not match the voltage of the power source provided to the IC. Voltage regulators are used to convert the input voltage to a supply voltage suitable for powering the circuitry and systems.

The description in this section and any corresponding figure(s) are included as background information materials. The materials in this section should not be considered as an admission that such materials constitute prior art to the present patent application.

### SUMMARY

A variety of apparatus and associated methods are contemplated according to exemplary embodiments. According to one exemplary embodiment, an apparatus includes an IC, which includes a voltage regulator. The voltage regulator includes a first transistor coupled to an input voltage of the voltage regulator and to a first output of the voltage regulator. The first transistor includes a native device of the IC. The voltage regulator further includes at least one diode-connected transistor coupled to the first output of the voltage regulator.

According to another exemplary embodiment, an apparatus includes an IC, which includes a voltage regulator. The voltage regulator includes a first transistor coupled to an input voltage of the voltage regulator and to a first output of the voltage regulator. The first transistor includes a native device of the IC. The voltage regulator also includes first and second diode-connected transistors coupled to the first output of the voltage regulator. The voltage regulator in addition includes a bias circuit including a current source coupled to a second transistor. The bias circuit provides a bias voltage to the first transistor and to the first diode-connected transistor.

According to another exemplary embodiment, a method of regulating an input voltage, by using a voltage regulator integrated in an IC, includes regulating the input voltage via a first transistor coupled to receive the input voltage and to provide a first regulated output voltage at a first output of the voltage regulator. The first transistor includes a native device of the IC. The method also includes using at least one diode-connected transistor to couple the first output to a ground potential.

### BRIEF DESCRIPTION OF THE DRAWINGS

The appended drawings illustrate only exemplary embodiments and therefore should not be considered as limiting the scope of the application or the claims. Persons of ordinary skill in the art will appreciate that the disclosed concepts lend themselves to other equally effective embodiments. In the drawings, the same numeral designators used in more than one drawing denote the same, similar, or equivalent functionality, components, or blocks.

FIG. 1 illustrates a circuit arrangement for an integrated circuit including a voltage regulator with improved characteristics according to an exemplary embodiment.

FIG. 2 depicts a circuit arrangement for an integrated circuit including a voltage regulator with improved characteristics according to another exemplary embodiment.

FIG. 3 shows a single-output regulator, with improved characteristics, according to an exemplary embodiment.

FIG. 4 illustrates a regulator, with improved characteristics, according to an exemplary embodiment.

FIG. 5 shows a regulator, with improved characteristics, according to another exemplary embodiment.

FIG. 6 depicts a multiple-output regulator, with improved characteristics, according to an exemplary embodiment.

FIG. 7 illustrates a single-output regulator, with improved characteristics, according to another exemplary embodiment.

FIG. 8 depicts a multiple-output regulator, with improved characteristics, according to another exemplary embodiment.

FIG. 9 illustrates a block diagram of an IC according to an exemplary embodiment.

FIG. 10 shows a block diagram of an IC according to another exemplary embodiment.

### DETAILED DESCRIPTION

The disclosed concepts relate generally to power conversion apparatus and associated methods. More specifically, the disclosure relates to apparatus, such as voltage regulators, and associated methods for regulating an input voltage to at least one regulated output voltage with a relatively low drop-out (LDO) voltage and with relatively low power consumption in the voltage regulator.

Typically, voltage regulators according to exemplary embodiments are included in or integrated in ICs. The voltage regulators receive an input voltage, for example, an input voltage provided to the IC via a pin of the IC package, and regulate the input voltage to provide one or more regulated output voltages at corresponding output(s) of the voltage regulator.

In some embodiments, the output voltage(s) of the voltage regulator are provided as outputs of the IC, for example, via one or more pins of the IC's packaging. In such a scenario, the output voltage(s) of the voltage regulator and, hence, of the IC, are used to supply power to circuitry external to the IC.

In other embodiments, the output voltage(s) of the voltage regulators are used to provide supply voltage(s) to one or more circuits, blocks of circuitry, sub-systems, etc. included in or integrated in the IC. An example of such ICs are microcontroller units (MCUs), although other types of IC may be used, as desired.

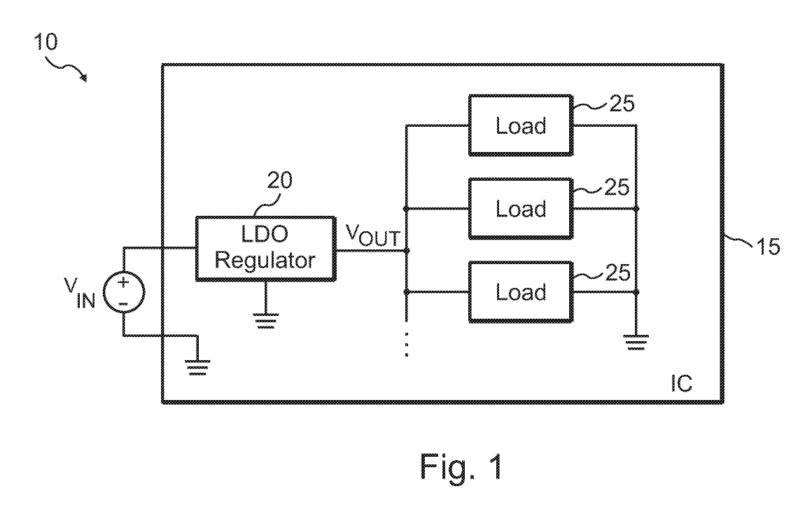

FIG. 1 illustrates a circuit arrangement 10 for an IC 15 that includes a single-output voltage regulator (labeled as “LDO Regulator,” generally “regulator”) 20 according to an exemplary embodiment. Voltage regulator 20 has improved characteristics, such as relatively low drop-out voltage and with relatively low power consumption, as noted above, and described below in detail.

Referring again to FIG. 1, regulator 20 accepts an input voltage from a source labeled “V_{IN}.” In the embodiment shown, regulator 20 regulates the input voltage to generate a single output voltage labeled “V_{OUT}.” The output voltage supplies power to one or more loads 25.

Generally, the input voltage has a higher level than does the output voltage of regulator 20. Regulator 20 regulates the input voltage to generate the output voltage. If the input voltage decreases, regulator 20 continues to regulate the output voltage until it reaches the “drop-out” voltage, at which point regulator 20 no longer can regulate the output voltage. As noted above and described below in detail, regulator 20 features a relatively low drop-out voltage.

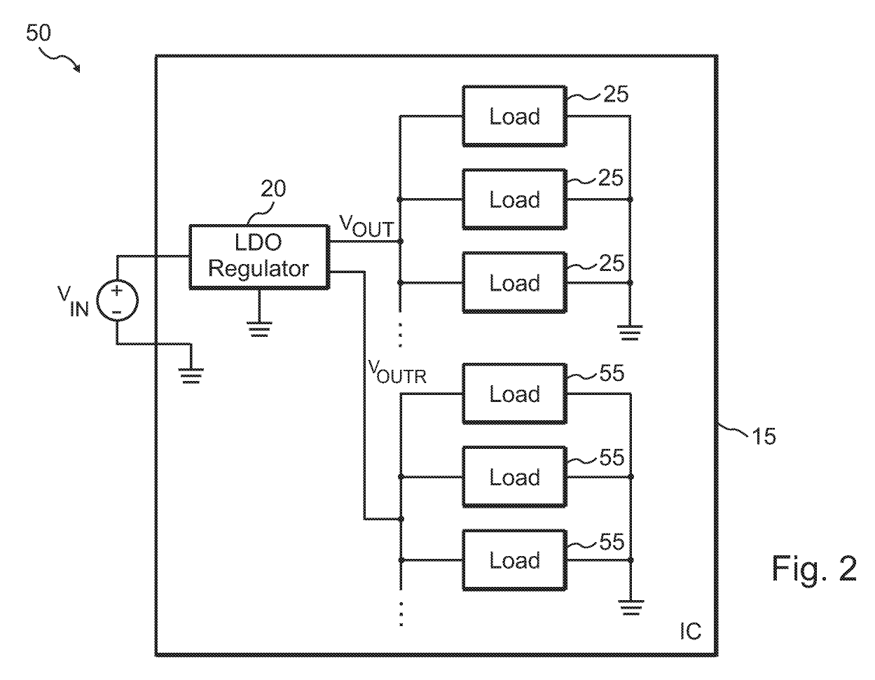

FIG. 2 depicts a circuit arrangement 50 for an IC 15 that includes a multiple-output voltage regulator 20, with improved characteristics, according to an exemplary embodiment. Regulator 20 has improved characteristics, such as relatively low drop-out voltage and with relatively low power consumption, as noted above, and described below in detail.

Referring again to FIG. 2, regulator 20 accepts an input voltage from a source labeled “V_{IN}.” In the embodiment shown, regulator 20 regulates the input voltage to generate two output voltages, labeled “V_{OUT}.” and “V_{OUTR}” (replica output voltage).

The output voltage V_{OUT} supplies power to one or more loads 25. Similarly, output voltage V_{OUTR} supplies power to one or more loads 55. The provision of two output voltages can provide benefits in some situations. For example, in some situations, a relatively low-noise output voltage may be desired, for instance, to supply power to noise-sensitive loads, such as amplifiers operating on input signals with relatively small amplitudes, low-noise amplifiers, etc.

One of the output voltages of regulator 20, for instance, the output voltage V_{OUT}, can be used to supply power to such loads. The other output voltage of regulator 20, for example, V_{OUTR}, can be used to supply power to other loads, for instance, digital circuitry.

By virtue of their switching operation, the digital circuitry might generate noise that would interfere with or degrade the operation of noise-sensitive loads. By supplying power to noise generating circuits through one output of regulator 20 and supplying power to noise-sensitive circuits through another output of regulator 20, the adverse effects of noise on noise-sensitive circuits may be reduced or eliminated (or nearly eliminated in a practical, non-ideal implementations).

Generally, the input voltage has a higher level than does the output voltages of regulator 20. Regulator 20 regulates the input voltage to generate the output voltages. If the input voltage decreases, regulator 20 continues to regulate the output voltages until it reaches the “drop-out” voltage, at which point regulator 20 no longer can regulate the output voltages. Similar to regulator 20 in FIG. 1, regulator 20 in FIG. 2 features a relatively low drop-out voltage.

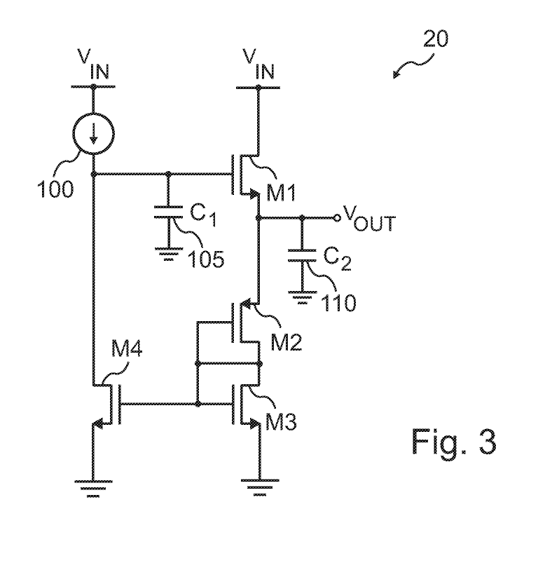

FIGS. 3-8 show a variety of configurations and circuit arrangements for regulator 20. The exemplary embodiments shown in FIGS. 3-8 use metal oxide semiconductor field effect transistors (MOSFETs). FIG. 3 shows a single-output regulator 20, with improved characteristics, according to an exemplary embodiment.

Regulator 20 includes bias circuitry. Specifically, the bias circuitry, included in a branch or “leg” of regulator 20, includes current source 100 and transistor M4. In exemplary embodiments, current source 100 provides a current that is proportional to absolute temperature (PTAT) current. The PTAT current can be used to make the output voltage more stable with temperature, but in other embodiments other types of current source may be used, as desired, depending on factors such as design and performance specifications, available technology, etc., as persons of ordinary skill in the art will understand.

Regulator 20 includes another branch or “leg,” which includes transistor M1, transistor M2, and transistor M3. Transistor M3 forms a current mirror with transistor M4. In other words, assuming similar transistor geometry (e.g., width to length (W/L) ratios), transistor M3 conducts the same current as does transistor M4 (if the transistor geometries differ, then the current through transistor M3 is a scaled version of the current through transistor M4, as persons of ordinary skill in the art will understand).

The DC current through transistor M4 is set by the DC current through transistor M3. Since the current through transistor M4 is also equal to the DC current provided by current source 100, the output voltage V_{OUT} will be forced to a voltage that ensures equal currents. Assuming similar transistor geometries, transistor M3 conducts the same current (or substantially or nearly the same in a practical, non-ideal implementation) as does transistor M4.

Transistors M1, M2, and M3 are coupled in a cascade arrangement. Thus, the current flowing through transistor M2 is the same (or substantially or nearly the same in a practical, non-ideal implementation) as the current flowing through transistor M3. Given that the current through transistor M3 is the same as the current provided by current source 100, the output current of current source 100 can be adjusted, modified, programmed, or set to determine the current flowing through transistors M2 and M3.

Transistors M2 and M3 are arranged in a diode-connected (or diode-coupled) configuration. More specifically, the drain of N-channel transistor M3 is coupled to its gate. Similarly, the drain of P-channel transistor M2 is coupled to its gate. Thus, the exemplary topology of regulator 20 in FIG. 3 includes two diode-connected transistors.

The source of transistor M2 is coupled to the output node of regulator 20. The source of transistor M1 is also coupled to the output node of regulator 20. The output node of regulator 20 provides the output voltage “V_{OUT}” to one or more loads (not shown). Capacitor 110 (labeled “C₂”) provides decoupling for the loads and filtering for the output voltage of regulator 20.

Regulator 20, via output V_{OUT}, provides an output current (load current) to one or more loads (not shown). Thus, the current through transistor M1 equals (or substantially or nearly equals in a practical, non-ideal implementation) the sum of the output current of regulator 20 and the current flowing through transistors M2 and M3.

During operation of regulator 20 to regulate the output voltage, transistor M1 operates in the saturation region. By operation of a negative feedback mechanism (described below), the gate voltage of transistor M1 is forced to a value that causes the current through transistors M2 and M3 to equal (or substantially or nearly equal in a practical, non-ideal implementation) the output current of current source 100. In other words, the gate voltage of transistor M1 equals the sum of the output voltage V_{OUT} of regulator 20 and the gate-source voltage (V_{GS}) of transistor M1.

As a result, reducing the threshold voltage of transistor M1 reduces the gate-source voltage drop across transistor M1 and, thus, reduces the drop-out voltage of regulator 20. In exemplary embodiments, such as the embodiment shown in FIG. 3, transistor M1 constitutes a native device or transistor of the IC in which regulator 20 resides or in which regulator 20 is integrated, i.e., transistor M1 has a threshold voltage of nearly zero (V_{T}≈0V). As a result, regulator 20 is a relatively low drop-out voltage regulator, or an LDO regulator.

The threshold voltage is a function of factors such as temperature, semiconductor fabrication process variation, and transistor dimensions, as persons of ordinary skill in the art will understand. In some embodiments, the threshold voltage of a native device may vary in a range, for example from −300 mV to 300 mV. Note that the threshold voltage of transistor M1 does not affect the output voltage of regulator 20. The output voltage is set by the voltage across transistor M2 and transistor M3, as is described below.

Note that the output voltage, V_{OUT}, is the sum of the voltage drops across transistor M2 and transistor M3. Put another way, the voltage drops across transistor M2 and transistor M3 affects the output voltage of regulator 20, i.e., transistor M2 and transistor M3 are coupled between the output of regulator 20 and ground potential (e.g., V_{SS}). In some embodiments, this property may be used to set (trimmed, configured, program, etc.) the output voltage of regulator 20.

More specifically, transistor M2 and/or transistor M3 may be designed, selected, and/or fabricated such that the output voltage of regulator 20 has a desired value. In some embodiments, the length of transistor M2 may be adjusted or selected to set the output voltage of regulator 20. In some embodiments, the width of transistor M2 may be adjusted or selected to set the output voltage of regulator 20. Similar choices may be made with respect to transistor M3, as desired.

Note that, rather than using a reference voltage, regulator 20 uses a reference current. More specifically, current source 100 provides the reference current for regulator 20. Given that the current through current source 100 and diode-connected transistors M2 and M3 are equal (or substantially or nearly equal in a practical, non-ideal implementation), the output voltage of regulator 20 is equal to the output current of current source 100 terminated in diode-connected transistors M2 and M3.

As noted above, regulator 20 employs negative feedback. More specifically, regulator 20 has a feedback path from its output node, through diode-connected transistors M2 and M3, and the common-source amplifier (transistor M4), back to the output node via transistor M1. The use of negative feedback helps to regulate the output voltage, V_{OUT}.

To illustrate the negative feedback action, consider the situation where V_{OUT} drops, for example, because the load current (output current of regulator 20, supplied to one or more loads) increases, i.e., more current is drawn through transistor M1. As a result of the lower V_{OUT}, the gate-source voltage of transistor M3 drops.

As a result, transistor M4 is turned on less, which increases the drain-source voltage of transistor M4, thus raising the gate and source voltages of transistor M1 in order for the mirrored currents through transistor M4 and transistor M3 (or M2) to be the same. Consequently, the output voltage V_{OUT} increases.

Conversely, assume that the output voltage V_{OUT} increases. As a result of the higher V_{OUT}, the gate-source voltage of transistor M3 rises.

Consequently, transistor M4 is turned on more, which decreases the drain-source voltage of transistor M4, thus lowering the gate and source voltages of transistor M1 in order for the mirrored currents through transistor M4 and transistor M3 (or M2) to be the same. Consequently, the output voltage V_{OUT} decreases.

Regulator 20 draws a relatively low quiescent current from the input source (V_{IN}). As a result, regulator 20 consumes relatively small amount of power internally. For example, if the output current of current source is 10 nA, the quiescent current of regulator 20 would be 20 nA (2×10 nA, i.e., the sum of the currents in two circuit branches). Note that relatively small output currents may be used for current source 100 because of the non-linear diode behavior of diode-connected transistors M2 and M3. In some embodiments, using two diode-connected transistors in series (transistors M2 and M3), an output voltage V_{OUT} of 1.2 Volts may be obtained.

As noted above, the output voltage depends on the voltage drops across diode-connected transistors M2 and M3, which in turn depends on the respective threshold voltages of those transistors. The threshold voltages of transistors M2 and M3 depends on various factors, such as their respective geometries, and the semiconductor fabrication process and technology used. Thus, depending on those factors, various values of output voltage may be obtained, as persons of ordinary skill in the art will understand.

Furthermore, note that the temperature coefficient of the output voltage V_{OUT} is determined by the temperature-dependence of the threshold voltages of diode-connected transistors M2 and M3 and the temperature coefficient of the PTAT bias current. If diode-connected transistors M2 and M3 are matched with the transistors in the V_{OUT} domain (e.g., transistors in an IC used in the load coupled to regulator 20), the output voltage V_{OUT} will track (or nearly track, in a practical, non-ideal implementation), and thus reduce current consumption of regulator 20 at relatively high temperatures.

As noted above, transistor M4 is coupled in a common-source amplifier configuration. Furthermore, transistor M4 is part of a negative feedback loop in regulator 20, as described above. Transistor M4 thus influences the loop gain of the negative feedback loop in regulator 20. Depending on the particular semiconductor fabrication process and technology used, in some embodiments, common-source amplifier transistor M4 may have a sufficiently large output resistance to make possible a loop gain in excess of 60 dB. If a higher loop gain is desired, a simple cascode transistor can be added at the drain node of transistor M4.

Capacitor 105 (labeled “C₁”) facilitates stability of the negative feedback loop in regulator 20. More specifically, capacitor 105 adds a dominant pole to the transfer function of the negative feedback loop in regulator 20. Given the relatively high output resistance of transistor M4 (in order to have a relatively large loop gain, as discussed above), the dominant pole is placed at the gate of transistor M1, i.e., via capacitor 105.

The use of capacitor 105 to provide a dominant pole affects the power supply rejection (PSR). More specifically, the PSR figure is limited by the negative feedback loop gain at DC and by capacitive coupling from the input source (V_{IN}) to the gate of transistor M1 at medium to relatively high frequencies (depending on component values). To improve the PSR value at medium frequencies, the value of capacitor 105 may be increased, as desired.

Using capacitor 105 to implement the dominant pole indicates the worst-case value of PSR will be for frequencies between ωₜ and ωₚₒ, where ωₜ and ωₚₒ represent, respectively, the unity-gain frequency of the negative feedback loop gain of regulator 20 and the pole at the output of regulator 20 (added because of capacitor 110).

Conversely, to provide negative feedback loop stability for regulator 20, the values of ωₜ and ωₚₒ should be selected such that ωₚₒ>2.2 ωₜ. Depending on the capacitance value of capacitor 105 (i.e., how large capacitor 105 is), the startup time of regulator 20 is either be limited by the unity-gain frequency of the feedback loop or by the slew-rate limit arising from the output current of current source 100 charging capacitor 105. In some embodiments, with a worst case PSR value of about −30 dB, a startup time of ˜200 μs may be obtained.

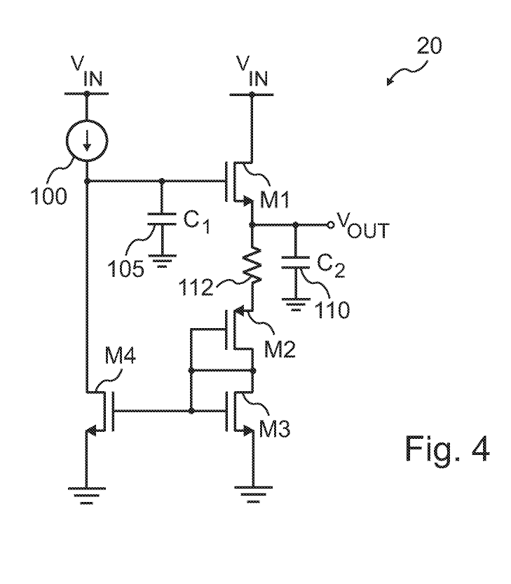

In some embodiments, it may be desirable to make the output voltage more stable with temperature. Since the threshold voltage of a MOSFET decreases with increasing temperature, the regulator output voltage V_{OUT} will also tend to decrease with temperature. FIG. 4 depicts a temperature compensated version of regulator 20 in FIG. 3. Referring to FIG. 4, a resistor 112 is coupled in series with diode-connected transistors M2 and M3. If current source 100 is a PTAT current, the voltage drop across resistor 112 will increase with temperature, effectively causing output voltage V_{OUT} to be more stable with temperature.

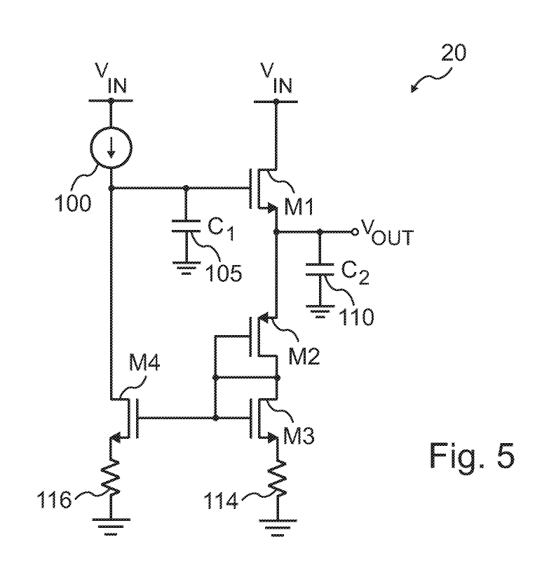

FIG. 5 depicts another temperature compensated version of regulator 20 in FIG. 3. The current mirror consisting of transistors M4 and M3 is source degenerated by using resistor 116 and resistor 114. If current source 100 is a PTAT current, the voltage over resistor 114 used to source degenerate transistor M3 will increase with temperature, effectively making the voltage more stable with temperature. Source degeneration also has the benefit of increasing the output impedance of the current mirror, as persons of ordinary skill in the art will understand.

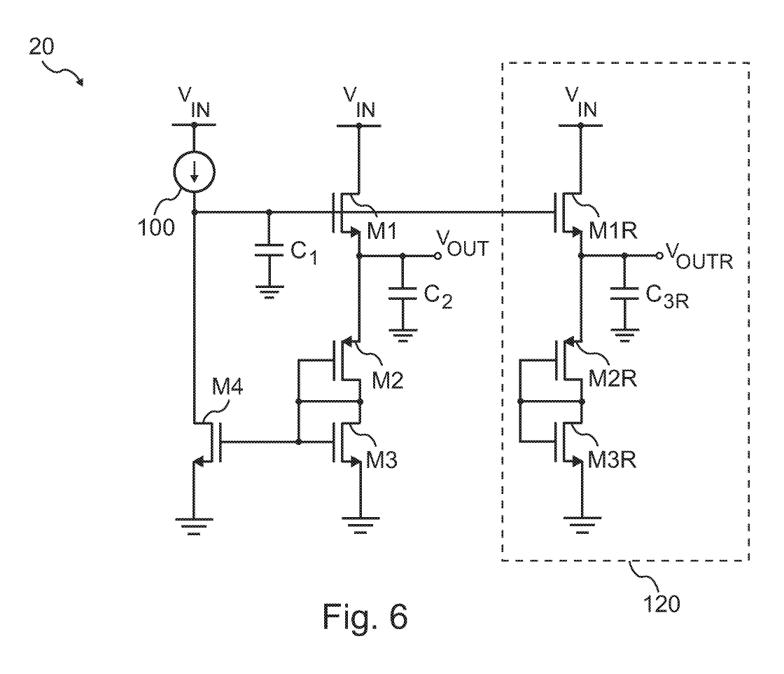

As noted, in some embodiments, one or more additional output voltages may be desired. FIG. 6 depicts a multiple-output regulator 20, with improved characteristics, according to an exemplary embodiment.

Specifically, regulator 20 in FIG. 6 is similar to regulator 20 in FIG. 3 and operates in a similar manner, except for the addition of extra output circuitry 120. Extra output circuitry 120 includes transistor M1R (similar to or the same as transistor M1), capacitor C3R (similar to or the same as capacitor C2), diode-connected transistor M2R (similar to or the same as diode-connected transistor M2), and diode-connected transistor M3R (similar to or the same as diode-connected transistor M3).

In other words, extra output circuitry 120 constitutes a replica of the output branch (i.e., the branch including transistor M1, capacitor C2, diode-connected transistor M2, and diode-connected transistor M3). Thus, transistor M1R operates in the same or similar manner as does transistor M1), capacitor C3R operates in the same or similar manner as capacitor C2, diode-connected transistor M2R operates in the same or similar manner as does diode-connected transistor M2, and diode-connected transistor M3R operates in the same or similar manner as diode-connected transistor M3.

Thus, extra output circuitry 120 operates similarly to the output branch of regulator 20, as described above, and with the same or similar considerations, design choices, and parameters and attributes as described above. Using extra output circuitry 120 provides an additional (or replica) output voltage, V_{OUTR}, as described above. Note that in some embodiments, some of the attributes of the circuit elements in extra output circuitry 120, such as transistor W/L ratios, transistor lengths, etc., may be modified in order to obtain different or specific attributes or characteristics, such as the value of V_{OUTR}, as desired. Note that extra output circuitry 120 may be added to other embodiments, as desired, such as the embodiments shown in FIGS. 4-5 and 7-8.

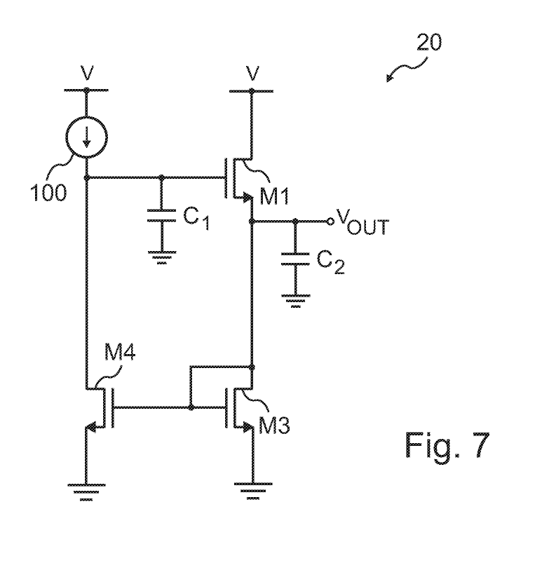

In some embodiments, rather than using two (or more) diode-connected transistors, such as transistors M2 and M3 in FIGS. 3-6, a single diode-connected transistor may be used. FIG. 7 illustrates a single-output regulator 20, with improved characteristics, according to another exemplary embodiment. Regulator 20 in FIG. 7 uses a single diode-connected transistor M3. Otherwise, regulator 20 in FIG. 7 operates similarly to regulator 20 in FIG. 3, described above.

Note that the use of a single diode-connected transistor M3, as shown in FIG. 7, causes a corresponding decrease in the output voltage V_{OUT}. Specifically, the output voltage of regulator 20 in FIG. 7 is equal to the drain-source voltage of diode-connected transistor M3, rather than the sum of the drain-source voltages of diode-connected transistors M2 and M3 in FIG. 3 or FIG. 6. Thus, regulator 20 in FIG. 7 may be used to supply power to loads with relatively small specified supply voltages (e.g., on the order of about 500 mV, depending on factors such as semiconductor fabrication technology, as persons of ordinary skill in the art will understand).

Conversely, using more than two diode-connected transistors will result in correspondingly larger values of the output voltage V_{OUT}. Thus, regulators with more than two diode-connected transistors in their output branches may be used to supply power to loads with relatively large specified supply voltages (e.g., larger than about 1.8 Volts, depending on factors such as semiconductor fabrication technology, as persons of ordinary skill in the art will understand).

Note that one or more extra output circuitry 120 may be used with regulators that use more than two diode-connected transistors, as desired, in order to provide additional or extra output voltages. Note that in some embodiments, some of the attributes of the circuit elements in extra output circuitry 120, such as transistor W/L ratios, transistor lengths, etc., may be modified in order to obtain different or specific attributes or characteristics, such as the value of V_{OUTR}, as desired.

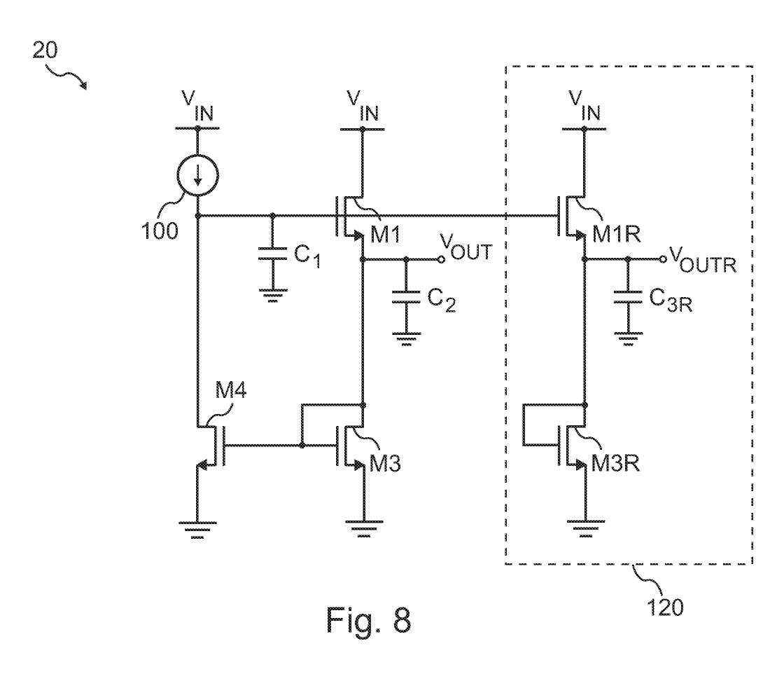

In some embodiments, one or more additional output voltages may be desired in regulators that use a single diode-connected transistor. FIG. 8 depicts a multiple-output regulator 20, with improved characteristics and a second output voltage, according to another exemplary embodiment.

Specifically, regulator 20 in FIG. 8 is similar to regulator 20 in FIG. 7 and operates in a similar manner, except for the addition of extra output circuitry 120. Extra output circuitry 120 includes transistor M1R (similar to or the same as transistor M1), capacitor C3R (similar to or the same as capacitor C2), and diode-connected transistor M3R (similar to or the same as diode-connected transistor M3).

Extra output circuitry 120 operates similarly to the output branch of regulator 20, as described above, and with the same or similar considerations, design choices, and parameters and attributes as described above. Using extra output circuitry 120 provides an additional (or replica) output voltage, V_{OUTR}, as described above. Note that in some embodiments, some of the attributes of the circuit elements in extra output circuitry 120, such as transistor W/L ratios, transistor lengths, etc., may be modified in order to obtain different or specific attributes or characteristics, such as the value of V_{OUTR}, as desired.

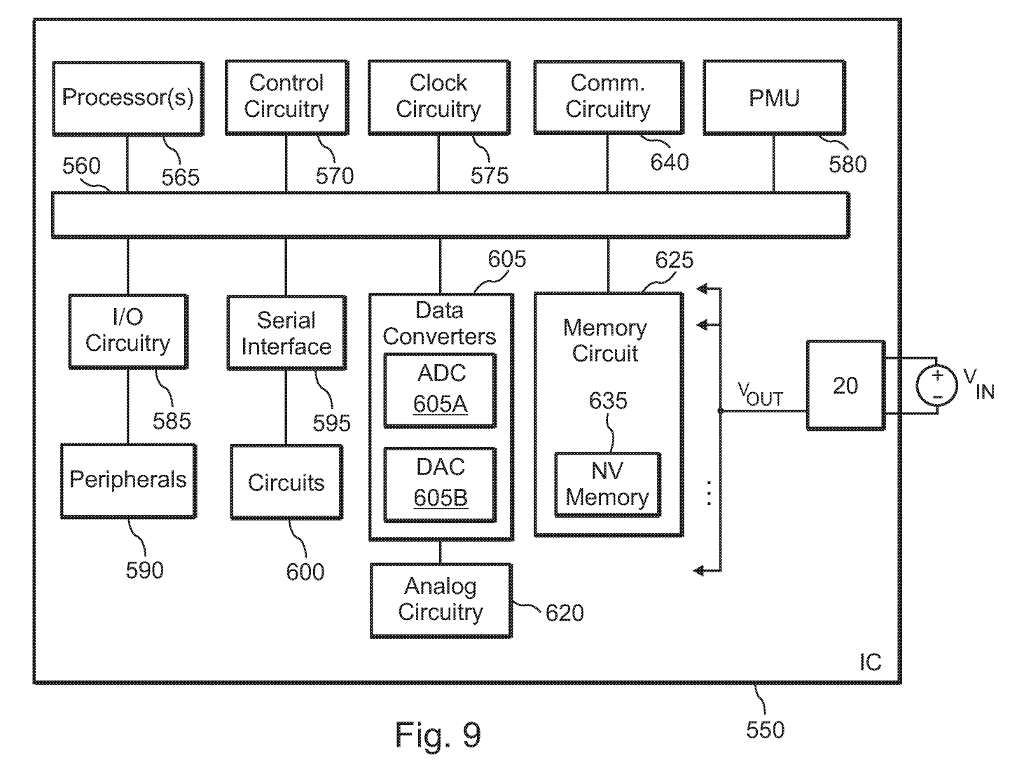

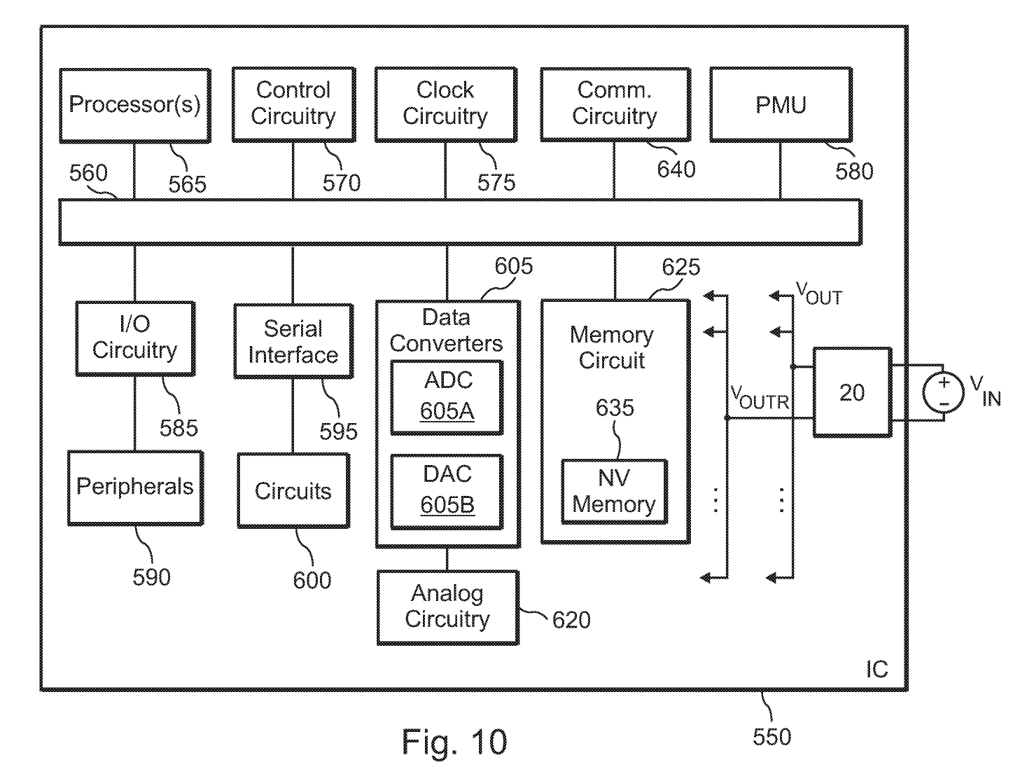

As noted above, regulators according to exemplary embodiments may be included in or integrated in various types of circuitry, together with other circuitry in such ICs, as desired. One example of such an IC constitutes an MCU. FIGS. 9 and 10 show MCUs that include regulators 20, having improved characteristics, as described above.

FIG. 9 illustrates a block diagram of an IC 550, specifically an MCU in the embodiment shown, according to an exemplary embodiment. IC 550 includes a number of blocks (e.g., processor(s) 565, data converter 605, I/O circuitry 585, etc.) that communicate with one another using a link 560. In exemplary embodiments, link 560 may constitute a coupling mechanism, such as a bus, a set of conductors or semiconductors for communicating information, such as data, commands, status information, and the like.

IC 550 may include link 560 coupled to one or more processors 565, clock circuitry 575, and power management circuitry or PMU 580. In some embodiments, processor(s) 565 may include circuitry or blocks for providing computing functions, such as central-processing units (CPUs), arithmetic-logic units (ALUs), and the like. In some embodiments, in addition, or as an alternative, processor(s) 565 may include one or more DSPs. The DSPs may provide a variety of signal processing functions, such as arithmetic functions, filtering, delay blocks, and the like, as desired.

Clock circuitry 575 may generate one or more clock signals that facilitate or control the timing of operations of one or more blocks in IC 550. Clock circuitry 575 may also control the timing of operations that use link 560. In some embodiments, clock circuitry 575 may provide one or more clock signals via link 560 to other blocks in IC 550.

In some embodiments, PMU 580 may reduce an apparatus's (e.g., IC 550) clock speed, turn off the clock, reduce power, turn off power, or any combination of the foregoing with respect to part of a circuit or all components of a circuit. Further, PMU 580 may turn on a clock, increase a clock rate, turn on power, increase power, or any combination of the foregoing in response to a transition from an inactive state to an active state (such as when processor(s) 565 make a transition from a low-power or idle or sleep state to a normal operating state).

Link 560 may couple to one or more circuits 600 through serial interface 595. Through serial interface 595, one or more circuits coupled to link 560 may communicate with circuits 600. Circuits 600 may communicate using one or more serial protocols, e.g., SMBUS, I²C, SPI, and the like, as person of ordinary skill in the art will understand.

Link 560 may couple to one or more peripherals 590 through I/O circuitry 585. Through I/O circuitry 585, one or more peripherals 590 may couple to link 560 and may therefore communicate with other blocks coupled to link 560, e.g., processor(s) 365, memory circuit 625, etc.

In exemplary embodiments, peripherals 590 may include a variety of circuitry, blocks, and the like. Examples include I/O devices (keypads, keyboards, speakers, display devices, storage devices, timers, etc.). Note that in some embodiments, some peripherals 590 may be external to IC 550. Examples include keypads, speakers, and the like.

In some embodiments, with respect to some peripherals, I/O circuitry 585 may be bypassed. In such embodiments, some peripherals 590 may couple to and communicate with link 560 without using I/O circuitry 585. Note that in some embodiments, such peripherals may be external to IC 550, as described above.

Link 560 may couple to analog circuitry 620 via data converter 605. Data converter 405 may include one or more ADCs 605B and/or one or more DACs 605A. The ADC(s) 615 receive analog signal(s) from analog circuitry 620, and convert the analog signal(s) to a digital format, which they communicate to one or more blocks coupled to link 560.

Analog circuitry 620 may include a wide variety of circuitry that provides and/or receives analog signals. Examples include sensors, transducers, and the like, as person of ordinary skill in the art will understand. In some embodiments, analog circuitry 620 may communicate with circuitry external to IC 550 to form more complex systems, sub-systems, control blocks, and information processing blocks, as desired.

Control circuitry 570 couples to link 560. Thus, control circuitry 570 may communicate with and/or control the operation of various blocks coupled to link 560. In addition, control circuitry 570 may facilitate communication or cooperation between various blocks coupled to link 560.

In some embodiments, control circuitry 570 may initiate or respond to a reset operation. The reset operation may cause a reset of one or more blocks coupled to link 560, of IC 550, etc., as person of ordinary skill in the art will understand. For example, control circuitry 570 may cause PMU 580 to reset to an initial state.

In exemplary embodiments, control circuitry 570 may include a variety of types and blocks of circuitry. In some embodiments, control circuitry 570 may include logic circuitry, finite-state machines (FSMs), or other circuitry to perform a variety of operations, such as the operations described above.

Communication circuitry 640 couples to link 560 and also to circuitry or blocks (not shown) external to IC 550. Through communication circuitry 640, various blocks coupled to link 560 (or IC 550, generally) can communicate with the external circuitry or blocks (not shown) via one or more communication protocols. Examples include USB, Ethernet, and the like. In exemplary embodiments, other communication protocols may be used, depending on factors such as specifications for a given application, as person of ordinary skill in the art will understand.

As noted, memory circuit 625 couples to link 560. Consequently, memory circuit 625 may communicate with one or more blocks coupled to link 560, such as processor(s) 365, control circuitry 570, I/O circuitry 585, etc. Memory circuit 625 provides storage for various information or data in IC 550, such as operands, flags, data, instructions, and the like, as persons of ordinary skill in the art will understand. Memory circuit 625 may support various protocols, such as double data rate (DDR), DDR2, DDR3, and the like, as desired.

In some embodiments, the memory read and/or write operations involve the use of one or more blocks in IC 550, such as processor(s) 565. A direct memory access (DMA) arrangement (not shown) allows increased performance of memory operations in some situations. More specifically, the DMA (not shown) provides a mechanism for performing memory read and write operations directly between the source or destination of the data and memory circuit 625, rather than through blocks such as processor(s) 565.

Memory circuit 625 may include a variety of memory circuits or blocks. In the embodiment shown, memory circuit 625 includes non-volatile (NV) memory 635. In addition, or instead, memory circuit 625 may include volatile memory (not shown). NV memory 635 may be used for storing information related to performance or configuration of one or more blocks in IC 550.

In addition, IC 550 includes regulator 20. Regulator 20 receives an input voltage (V_{IN}), and provides a single output voltage (V_{OUT}). Regulator 20 may have the circuit arrangement or configuration of any of the single-output regulators 20 described above. Regulator 20 may provide the output voltage V_{OUT} as a supply voltage or other voltage (e.g., a reference voltage, a bias voltage, etc.) to any of the blocks or circuits shown in IC 550.

In some situations, an IC may include some circuitry that operates using one supply voltage, and other circuitry that operates using a different supply voltage. In such situations, either regulator 20 may be replicated or duplicated, or a regulator with multiple output voltages may be used.

FIG. 10 shows a block diagram of an IC 550, including a multiple-output regulator 20, according to another exemplary embodiment. IC 550 includes the same circuitry shown and described above in connection with FIG. 9, such as processor(s) 565, control circuitry 570, etc.

In contrast to the single-output regulator 20 in FIG. 9, however, regulator 20 in IC 550 provides two output voltages (V_{OUT}, V_{OUTR}). Regulator 20 receives an input voltage (V_{IN}), and provides an output voltage (V_{OUT}) and an additional output voltage (V_{OUTR}). Regulator 20 may have the circuit arrangement or configuration of any of the multiple-output regulators 20 described above.

Regulator 20 may provide the output voltage V_{OUT} as a supply voltage or other voltage (e.g., a reference voltage, a bias voltage, etc.) to any of the blocks or circuits shown in IC 550. In addition, regulator 20 may provide the output voltage V_{OUTR} as a supply voltage or other voltage (e.g., a reference voltage, a bias voltage, etc.) to any of the blocks or circuits shown in IC 550. If additional output voltages are desired, extra output circuitry 120, described above, may be used to provide such output voltages.

Referring to the figures, persons of ordinary skill in the art will note that the various blocks shown might depict mainly the conceptual functions and signal flow. The actual circuit implementation might or might not contain separately identifiable hardware for the various functional blocks and might or might not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation. Other modifications and alternative embodiments in addition to the embodiments in the disclosure will be apparent to persons of ordinary skill in the art. Accordingly, the disclosure teaches those skilled in the art the manner of carrying out the disclosed concepts according to exemplary embodiments, and is to be construed as illustrative only. Where applicable, the figures might or might not be drawn to scale, as persons of ordinary skill in the art will understand.

The particular forms and embodiments shown and described constitute merely exemplary embodiments. Persons skilled in the art may make various changes in the shape, size and arrangement of parts without departing from the scope of the disclosure. For example, persons skilled in the art may substitute equivalent elements for the elements illustrated and described. Moreover, persons skilled in the art may use certain features of the disclosed concepts independently of the use of other features, without departing from the scope of the disclosure.

1. An apparatus comprising:
an integrated circuit (IC) comprising:
a voltage regulator comprising:
a first transistor coupled to an input voltage of the voltage regulator and to a first output of the voltage regulator, wherein the first transistor comprises a native device of the IC; and
at least one diode-connected transistor coupled to the first output of the voltage regulator.

2. The apparatus according to claim 1, wherein the voltage regulator comprises a resistor coupled in series with the at least one diode-connected transistor.

3. The apparatus according to claim 2, further comprising:
a second transistor coupled to the input voltage of the voltage regulator, to the bias circuit, and to a second output of the voltage regulator, wherein the second transistor comprises a native device of the IC; and
a pair of diode-connected transistors coupled to the second output of the voltage regulator.

4. (canceled)

5. (canceled)

6. The apparatus according to claim 1, further comprising a first capacitor coupled to a gate of the first transistor.

7. The apparatus according to claim 6, wherein the first capacitor provides a dominant pole of a transfer function of a negative feedback loop of the voltage regulator.

8. The apparatus according to claim 6, wherein the transfer function of the negative feedback loop of the voltage regulator further comprises a pole corresponding to a capacitor coupled to the first output of the voltage regulator, wherein the pole has a frequency that is larger than 2.2 times a frequency of the dominant pole.

9. The apparatus according to claim 2, wherein a length of one of the two diode-connected transistors is selected in order to trim the output voltage of the voltage regulator.

10. An apparatus comprising:
a microcontroller unit (MCU), integrated as an integrated circuit (IC), comprising:
a voltage regulator comprising:
a first transistor coupled to an input voltage of the voltage regulator and to a first output of the voltage regulator, wherein the first transistor comprises a native device of the IC;
first and second diode-connected transistors coupled to the first output of the voltage regulator; and
a bias circuit comprising a current source coupled to a second transistor, the bias circuit providing a bias voltage to the first transistor and to the first diode-connected transistor.

11. The apparatus according to claim 10, further comprising a first capacitor coupled to a gate of the first transistor and to the current source.

12. The apparatus according to claim 10, further comprising:
a first resistor coupled in series with the first and second diode-connected transistors; and
a second resistor coupled in series with the second transistor.

13. The apparatus according to claim 10, wherein the first diode-connected transistor forms a current mirror with the second transistor.

14. The apparatus according to claim 10, further comprising:
a third transistor coupled to the input voltage of the voltage regulator, to the bias circuit, and to a second output of the voltage regulator, wherein the third transistor comprises a native device of the IC; and
third and fourth diode-connected transistors coupled to the second output of the voltage regulator.

15. A method of regulating an input voltage, by using a voltage regulator integrated in an integrated circuit (IC), the method comprising:
regulating the input voltage via a first transistor coupled to receive the input voltage and to provide a first regulated output voltage at a first output of the voltage regulator, wherein the first transistor comprises a native device of the IC; and
using at least one diode-connected transistor to couple the first output to a ground potential.

16. The method according to claim 15, further comprising:
regulating the input voltage via a second transistor coupled to receive the input voltage and coupled to a second output of the voltage regulator to provide the second regulated output voltage, wherein the second transistor comprises a native device of the IC; and
using one or more diode-connected transistors to couple the second output to a ground potential.

17. The method according to claim 15, further comprising using a first capacitor to provide a dominant pole of a transfer function of a negative feedback loop of the voltage regulator.

18. The method according to claim 17, further comprising using a second capacitor coupled to the first output of the voltage regulator to provide a pole corresponding to the second capacitor, wherein the pole has a frequency that is larger than 2.2 times a frequency of the dominant pole.

19. The method according to claim 15, wherein using at least one diode-connected transistor to couple the first output to the ground potential comprises using two diode-connected transistors.

20. (canceled)

21. The method according to claim 17, wherein the transfer function of the negative feedback loop of the voltage regulator further comprises a pole corresponding to a capacitor coupled to the first output of the voltage regulator, wherein the pole has a frequency that is larger than 2.2 times a frequency of the dominant pole.

22. The method according to claim 15, wherein using one or more diode-connected transistors to couple the second output to a ground potential further comprises using a resistor coupled in series with the one or more diode-connected transistors.

23. The method according to claim 22, wherein a length of one of the two diode-connected transistors is selected in order to trim the output voltage of the voltage regulator.
